(19) United States
(12) Patent Application Publication
(10) Pub. No.: US 2007/0245700 A1
(43) Pub. Date: Oct. 25, 2007

(54) AIR FILTERING DEVICE

(76) Inventor: Yimin ZHU, Chung-Ching City (CN)

Correspondence Address: LADAS & PARRY LLP, 224 SOUTH MICHIGAN AVENUE, SUITE 1600, CHICAGO, IL, 60604, US

(21) Appl. No.: 11/734,825

(22) Filed: Apr. 13, 2007

(30) Foreign Application Priority Data
Apr. 20, 2006 (CN) 200610054232.0

(51) Int. Cl. B01D 51/00; B01D 46/00

(52) U.S. Cl. 55/418; 55/472

(57) ABSTRACT

An air filtering device includes a housing formed with an air inlet and an air outlet, an air filter core disposed in the housing at a position corresponding to the air outlet, and an air guide unit. The air guide unit includes a plurality of baffle plates extending from the housing toward one side of the air filter core opposite to the air outlet and defining a plurality of air ducts. Air that flows into the housing via the air inlet is guided by the baffle plates to flow through the air ducts toward the side of the air filter core before being filtered by the air filter core. The filtered air exits the housing via the air outlet.

### CROSS-REFERENCE TO RELATED APPLICATION

This application claims priority of Chinese Patent Application No. 200610054232.0, filed on Apr. 20, 2006.

### BACKGROUND OF THE INVENTION

1. Field of the Invention

The invention relates to an air filtering device, more particularly to an air filtering device for supplying filtered air to a machine.

2. Description of the Related Art

A conventional air filtering device usually filters air and supplies filtered air to a machine, such as an engine. The mixture of filtered air and combustible liquid in the machine permits combustion for supplying mechanical power. As shown in FIGS. 1, 2, and 3, the conventional air filtering device 1 includes an upper housing part 11 having one side formed with an air inlet 111, a lower housing part 13 that is coupled to and that cooperates with the upper housing part 11 to define an inner space 12, a middle layer portion 17 disposed in the lower housing part 13, and a pair of air filter cores 14, 15 overlapping each other. The lower housing part 13 is formed with an air outlet 133 corresponding in position to the stack of air filter cores 14, 15.

The middle layer portion 17 includes a main body 171, a pair of spaced apart guide walls 172 disposed on the main body 171, a surrounding wall 174 disposed on the main body 171, and a plurality of housing ribs 175 that crisscross each other and that are disposed in the surrounding wall 174. The two guide walls 172 cooperatively define an air duct 176 that has a first end 177 corresponding to the air inlet 111, and a second end 178 facing the surrounding wall 174.

The air filter cores 14, 15 are confined within the surrounding wall 174 and are supported by the housing ribs 175. The conventional air filtering device 1 further includes a press strip 16 that is welded to the bottom side of the upper housing part 11, and that is in a form of a frame corresponding to the outline at the top side of the air filter core 14. When the upper housing part 11 is coupled to the lower housing part 13, the stack of air filter cores 14, 15 will be pressed from the top by the press strip 16 so as to be positioned stably inside the surrounding wall 174.

Air that flows into the inner space 12 via the air inlet 111 is guided by the guide walls 172 of the middle layer portion 17 to flow through the air duct 176 to the surrounding wall 174, then flows through the air filter cores 14, 15, and finally exits the air filtering device 1 via the air outlet 133. Since the air filter core 14 is pressed from the top side by the press strip 16, most of the air is allowed to flow only through the gap between the press strip 16 and the upper housing part 11, and enter the air filter core 14 at the upper corner adjacent to the second end 178 of the air duct 176. Therefore, most of the air is filtered only by a part of the air filter cores 14, 15, thereby resulting in a relatively ineffective filtration.

### SUMMARY OF THE INVENTION

Therefore, the object of the present invention is to provide a relatively effective air filtering device.

Accordingly, an air filtering device of the present invention includes a housing formed with an air inlet and an air outlet, an air filter core disposed in the housing at a position corresponding to the air outlet, and an air guide unit. The air guide unit includes a plurality of baffle plates extending from the housing to the air filter core and defining a plurality of air ducts. Air that flows into the housing via the air inlet is guided by the baffle plates to flow through the air ducts before being filtered by the air filter core. The filtered air exits the housing via the air outlet.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional air filtering device;

FIG. 2 is a schematic bottom view of an upper housing part of the conventional air filtering device;

FIG. 3 is an assembled sectional view of the conventional air filtering device;

FIG. 4 is an exploded perspective view of a preferred embodiment of an air filtering device according to this invention;

FIG. 5 is a bottom perspective view of a second housing part of the preferred embodiment;

FIG. 6 is a top view of a first housing part of the preferred embodiment; and

FIG. 7 is an assembled sectional view of the preferred embodiment, illustrating movement of unfiltered air inside the preferred embodiment.

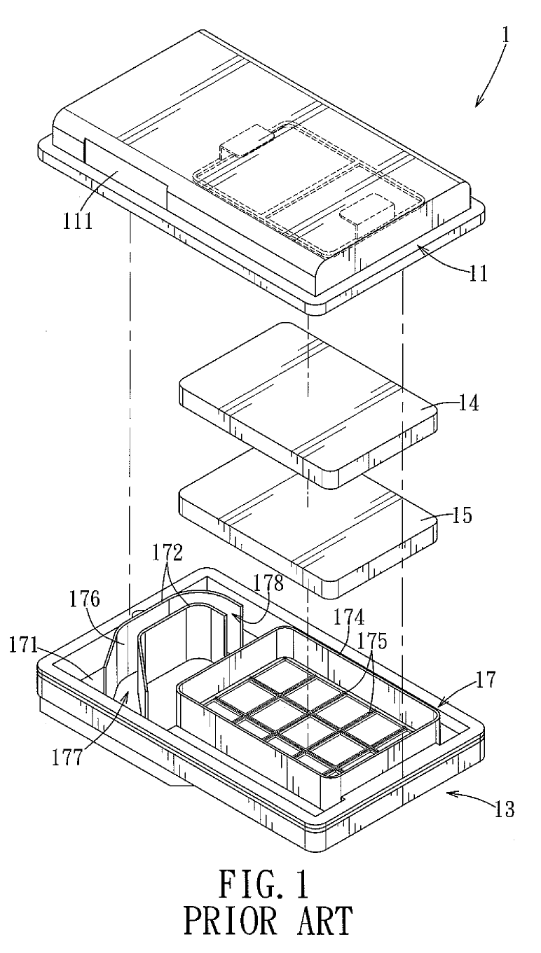

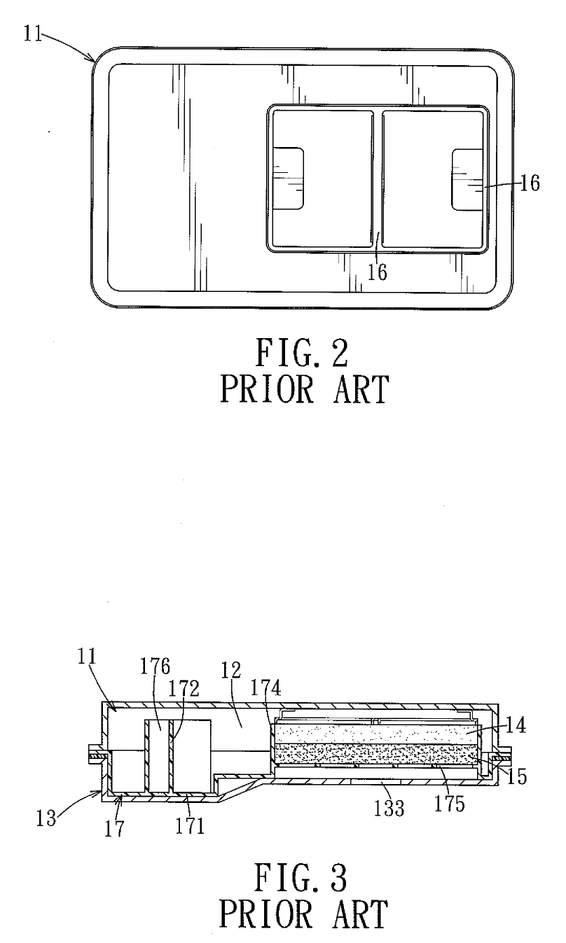

### DETAILED DESCRIPTION OF THE PREFERRED EMBODIMENT

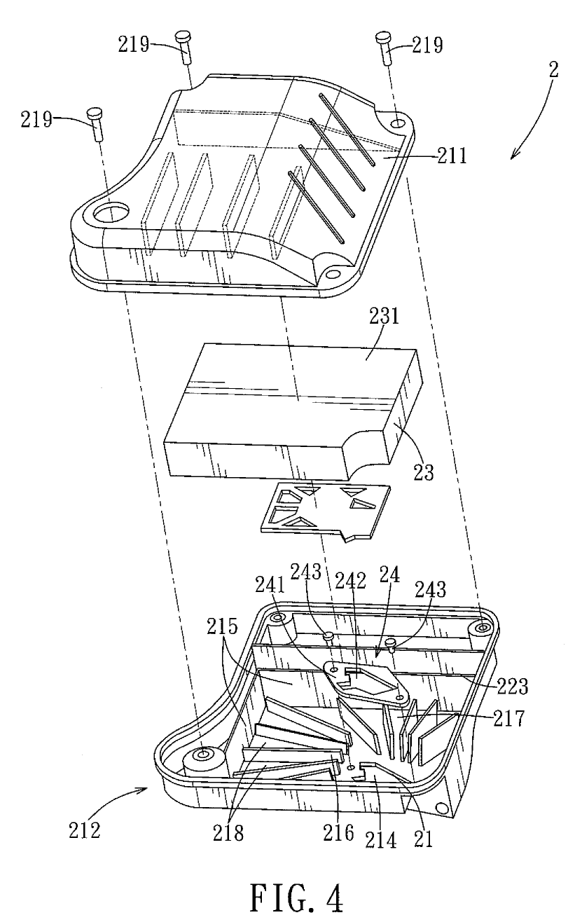

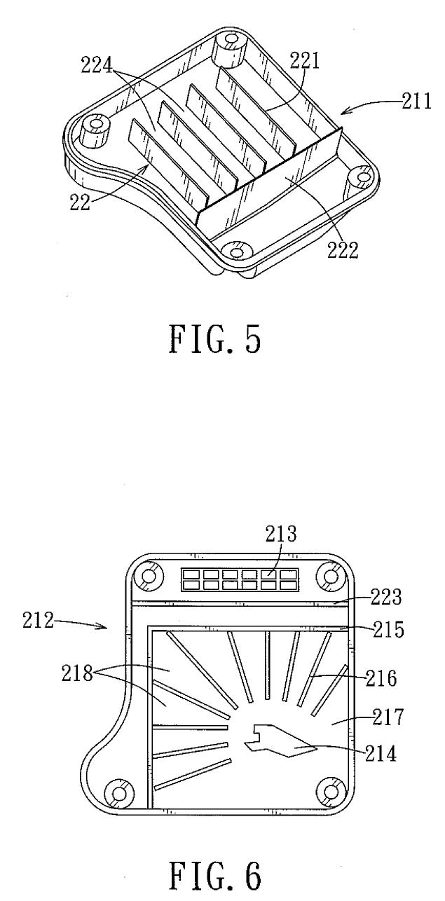

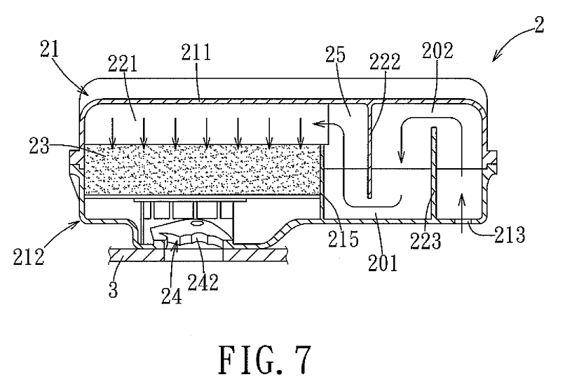

As shown in FIGS. 4 to 7, the preferred embodiment of an air filtering device 2 according to the present invention is adapted for mounting on a machine 3 (only the connecting part of the machine 3 is illustrated in FIG. 7) such that filtered air that exits the air filtering device 2 is supplied to the machine 3. The air filtering device 2 includes a housing 21, an air guide unit 22, an air filter core 23, a filter mounting plate 24, and a fastening unit 243. The housing 21 includes first and second housing parts 212, 211 that are coupled removably to each other and that cooperatively define an inner space 25. In this embodiment, the first and second housing parts 212, 211 are coupled through a plurality of screw bolts 219.

The first housing part 212 of the housing 21 is formed with an air inlet 213 in a form of a grid and an air outlet 214 spaced apart from the air inlet 213. The first housing part 212 has an inclined wall segment formed with the air inlet 214. The first housing part 212 of the housing 21 is further formed with a pair of barrier walls 215 that surround the air outlet 214, that extend from the first housing part 212 toward the second housing part 211, and that cooperatively define a receiving groove 217 for receiving the air filter core 23.

The air guide unit 22 includes a plurality of guide plates 216 that extend from the first housing part 212 of the housing 21 toward the second housing part 211, and that define a plurality of guide ducts 218. The guide plates 216 are not higher than and are surrounded by the barrier walls 215 in the first housing part 212. The guide plates 216 are disposed in radial directions relative to the air outlet 214 in the first housing part 212.

The air guide unit 22 further includes four spaced apart baffle plates 221 and first and second baffle members 222, 223. The baffle plates 221 extend from the second housing part 211 of the housing 21 toward a side 231 of the air filter core 23 opposite to the air outlet 214. The baffle plates 221 are disposed parallel to each other and define a plurality of air ducts 224. The first baffle member 222 is in a form of a plate and extends from the second housing part 211 toward the first housing part 212. The first baffle member 222 is transverse to the baffle plates 221 and forms a first gap 201 with the first housing part 212. The second baffle member 223 is in a form of a plate, and extends from the first housing part 212 toward the second housing part 211. The second baffle member 223 is transverse to the baffle plates 221 and forms a second gap 202 with the second housing part 211.

The filter mounting plate 24 is disposed in the first housing part 211 of the housing 21, and includes a metal plate body 241 formed with a through hole 242 that is disposed to correspond to the air outlet 214 in the first housing part 212. The fastening unit 243 extends through the filter mounting plate 24 and the first housing part 212 of the housing 21, and is adapted to fasten the housing 21 to the machine 3.

Air that flows into the housing 21 via the air inlet 213 meanders through the first and second gaps 201, 202 in the housing 21 and is then guided by the baffle plates 221 in the second housing part 211 to flow through the air ducts 224 toward the side 231 of the air filter core 23 before being filtered by the air filter core 23. The filtered air is guided by the guide plates 216 of the housing 21 to flow from the air filter core 23 to the air outlet 214 in the housing 21 through the guide ducts 218. The filtered air finally exits the housing 21 via the air outlet 214 and enters the machine 3.

According to the preferred embodiment, air that flows into the housing 21 via the air inlet 213 is limited to flow through the first and second gaps 201, 202 to the air filter core 23 rather than flowing directly to the air filter core 23, thereby resulting in homogenization of the air. In addition, the design of the first and second gaps 201, 202 slows down the velocity of the air that flows into the housing 21 via the air inlet 213, thereby reducing the generation of noise.

The air filter core 23 is pressed by the baffle plates 221 and is surrounded by the barrier walls 215 in the first housing part 212, so that the air filter core 23 is positioned firmly in the receiving groove 217. Since unfiltered air is guided by the baffle plates 221 of the air guide unit 22 to flow through the air ducts 224 in the first housing part 212, the unfiltered air is directed to flow evenly through the air filter core 23, i.e., the air flows through a large part of the air filter core 23 rather than flowing through only a small part of the same. Compared to the prior art, the air filter core 23 of the present invention filters air more effectively and is more durable.

The structure of the guide plates 216 in the first housing part 212 not only guides filtered air to flow through the guide ducts 218 and the air outlet 214 in the first housing part 212 to the machine 3, but also avoids producing a single airflow in the machine 3 for improving combustion.

The grid-shaped structure of the air inlet 213 in the first housing part 212 covers a relatively large area for a relatively large air inflow. Compared to a single-hole air inlet with the same size, the design of the air inlet 213 ensures a stronger structure of the first housing part 212, and can further prevent floccules from blocking up the air inlet 213.

It should be noted that, while this invention is exemplified using a pair of baffle members 222, 223, only one baffle member may be employed in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An air filtering device, comprising:
a housing formed with an air inlet and an air outlet;
an air filter core disposed in said housing at a position corresponding to said air outlet; and
an air guide unit including a plurality of baffle plates extending from said housing toward one side of said air filter core opposite to said air outlet and defining a plurality of air ducts;
wherein air that flows into said housing via said air inlet is guided by said baffle plates to flow through said air ducts toward said side of said air filter core before being filtered by said air filter core; and
wherein filtered air exits said housing via said air outlet.

2. The air filtering device as claimed in claim 1, wherein said housing includes first and second housing parts that are coupled removably to each other, said air inlet and said air outlet being formed in said first housing part.

3. The air filtering device as claimed in claim 2, wherein said baffle plates extend from said second housing part toward said first housing part.

4. The air filtering device as claimed in claim 3, wherein said baffle plates are disposed parallel to each other.

5. The air filtering device as claimed in claim 2, wherein said air guide unit further includes a baffle member that is in a form of a plate, that extends from said second housing part toward said first housing part, that is transverse to said baffle plates, and that forms a gap with said first housing part,
wherein the air that flows into said housing via said air inlet flows through the gap before flowing through said air ducts.

6. The air filtering device as claimed in claim 2, wherein said air guide unit further includes a baffle member that is in a form of a plate, that extends from said first housing part toward said second housing part, that is transverse to said baffle plates, and that forms a gap with said second housing part,
wherein the air that flows into said housing via said air inlet flows through the gap before flowing through said air ducts.

7. The air filtering device as claimed in claim 2, wherein said air guide unit further includes:
a first baffle member that is in a form of a plate, that extends from said second housing part toward said first housing part, that is transverse to said baffle plates, and that forms a first gap with said first housing part; and
a second baffle member that is in a form of a plate, that extends from said first housing part toward said second housing part, that is transverse to said baffle plates, and that forms a second gap with said second housing part;
wherein the air that flows into said housing via said air inlet flows through the first and second gaps before flowing through said air ducts.

8. The air filtering device as claimed in claim 2, wherein said first housing part is formed with a pair of barrier walls that cooperatively define a receiving groove for receiving said air filter core.

9. The air filtering device as claimed in claim 2, wherein said air guide unit further includes a plurality of guide plates that extend from said first housing part toward said second housing part and that define a plurality of guide ducts for guiding the filtered air from said air filter core to said air outlet.

10. The air filtering device as claimed in claim 9, wherein said guide plates are disposed in radial directions relative to said air outlet.

11. The air filtering device as claimed in claim 1, said air filtering device being adapted for mounting on a machine such that the filtered air that exits said air filtering device is supplied to the machine, said air filtering device further comprising:
a filter mounting plate disposed in said housing and including a metal plate body formed with a through hole that is disposed to correspond to said air outlet; and
a fastening unit that extends through said filter mounting plate and said housing and that is adapted to fasten said housing to the machine.
